(19) United States
(12) Patent Application Publication
(10) Pub. No.: US 2010/0293148 A1
(43) Pub. Date: Nov. 18, 2010

(54) NETWORK ATTACHED STORAGE BACKUP

(76) Inventors: Paul Cesario, Ft. Collins, CO (US); David H. Hanes, Loveland, CO (US); Charles Martin McJilton, Longmont, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/863,494

(22) PCT Filed: Jan. 29, 2008
(86) PCT No.: PCT/US08/52313

§ 371 Date: Jul. 19, 2010

(51) Int. Cl. G06F 17/00; G06F 15/177

(52) U.S. Cl. 707/652; 709/222; 707/E17.007

(57) ABSTRACT

In one embodiment a network attached storage device comprises at least one storage media, a detection module to detect at least one computing device on a network, a configuration module to configure, in network attached storage device, backup settings, a coordination module to coordinate backup procedures, a network attached storage backup module to backup at least a portion of data from a computing device to the storage media, and a device backup module to backup only modified data from a computing device.

### BACKGROUND

The term Network Attached Storage (NAS) refers to a dedicated data storage device(s) connected directly to a computer network to provide centralized data access and storage services to one or more network clients such as, e.g., a personal computer. In some circumstances it may be useful to back up data residing on the one or more network clients to a network attached storage device.

### BRIEF DESCRIPTION OF THE DRAWINGS

FIG. 1 is a schematic illustration of one embodiment of network attached storage environment.

FIG. 2 is a schematic illustration of an exemplary network attached storage device.

FIG. 3 is a flowchart illustrating operations in one embodiment of a backup configuration in network attached storage.

FIG. 4 is a flowchart illustrating operations in one embodiment of a backup procedure in network attached storage.

### DETAILED DESCRIPTION

Described herein are exemplary systems and methods for data backup in network attached storage. The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

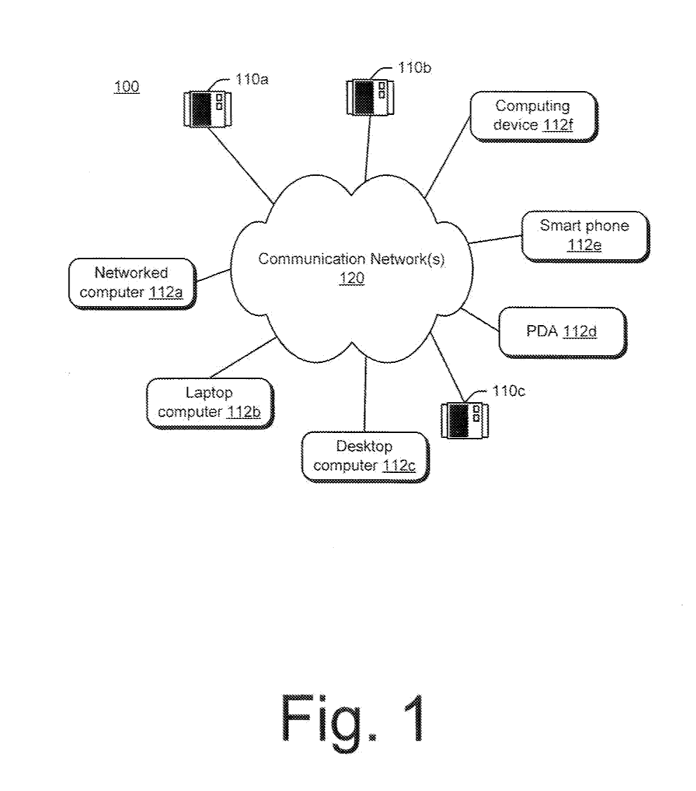

FIG. 1 is a schematic illustration of one embodiment of network attached storage environment. Environment 100 may comprise one or more network attached storage devices 110a, 110b, 110c connected to one or more network clients 112a, 112b, 112c, 112d, 112e, 112f by a communication network 120.

Network attached storage devices 110a, 110b, 110c may be implemented as one or more communicatively connected storage devices. Exemplary storage devices may comprise, but are not limited to, the Media Vault™ line of storage devices commercially available form Hewlett-Packard Corporation of Palo Alto, Calif., USA. In some embodiments, at least a portion of communication network 120 may be implemented as a private, dedicated network such as, e.g., a local area network (LAN) or a wide area network (WAN). Alternatively, portions of communication network 120 may be implemented using public communication networks such as, e.g., the Internet, pursuant to a suitable communication protocol such as, e.g. TCP/IP.

Network clients 112a, 112b, 112c, 112d, 112e, 112f may be implemented as computing devices such as, e.g., a networked computer 112a, a laptop computer 112b, a desktop computer 112c, a personal digital assistant (PDA) 112d, a smart phone 112e, other computing devices 112f or the like. Applications running on network clients 112a, 112b, 112c, 112d, 112e, 112f may initiate file access requests to access information stored in network attached storage devices 110a, 110b, 110c. Network attached storage devices 110a, 110b, 110c receive file access requests and, in response, locate and return the requested information to the network client that originated the request.

In some embodiments, a network attached storage device may monitor network traffic to identify any devices that may have been added to the network. In operation, a network attached storage device may detect a computing device on the network. The network attached storage device may then detect whether a computing device contains required firmware or software to allow for automatic configuration and backup. In some embodiments, a network attached storage device may also detect whether other network attached storage devices are on the network. In operation, the network attached storage device may then be configured to determine what data on a computing device is backed up, and when a backup is to be performed. In some embodiments, multiple network attached storage devices may be coordinated to distribute backup loads or as redundant backup. In operation, a client may request a backup, or a network attached storage device may initiate a backup request depending on the configuration. In some embodiments, a network attached storage device may use key identifiers to label data so that identical data from various devices is only stored once. In operation, using a key identifier for backup data would comprise generating and assigning a key identifier to a block of data. The key identifier allows for the detection of the same key if one already exists. If the same data already exists elsewhere, a link to the storage location may be stored instead of the data. In some embodiments, a network attached storage device may perform an intelligent backup by only backing up data that has been modified since a previous backup.

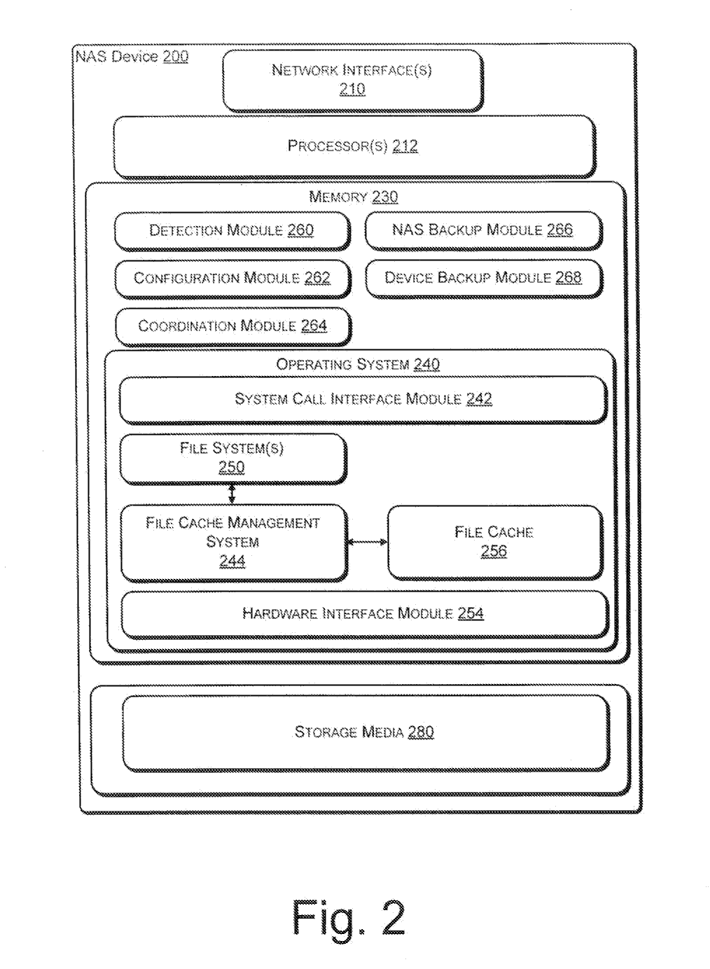

FIG. 2 is a schematic illustration of one embodiment of a network attached storage (NAS) device 200, which may be used to implement one or more of network attached storage devices 110a, 110b, 110c depicted in FIG. 1. Referring to FIG. 2, network storage device 200 comprises one or more network interfaces 210 which enables a communication connection with a network such as, e.g., network 120.

Network interface 210 may comprise an input/output (I/O) port to provide a physical connection with a network. For example, network interface 210 may comprise an Ethernet port. Network interface 210 may comprise a network interface card (NIC), also commonly referred to as a network adapter or a network card. The NIC manages I/O operations to enable NAS device 200 to communicate over a network. Alternatively, the operations of the NIC may be implemented on a main circuit board such as, e.g., a motherboard of NAS device 200.

NAS device 200 further comprises at least one processor 212. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

NAS device 200 further comprises system random access memory and/or read-only memory 230. Memory 230 comprises an operating system 240 for managing operations of NAS device 200. In one embodiment, operating system 240 comprises a hardware interface module 254 that provides an interface to system hardware. The particular embodiment of operating system 240 is not critical to the subject matter described herein. Operating system 240 may be embodied as a UNIX operating system or any derivative thereof (e.g., Linux, Solaris, etc.) or as a Windows® brand operating system.

Operating system 240 comprises (or interfaces with) a file system(s) 250 that manages files used in the operation of NAS device 200. For example, file system(s) 250 may implement one or more file systems such as FAT, NTFS, ext3, reiser, or the like. In one embodiment, operating system 240 may comprise a file cache management system 244 interposed logically between the file system(s) 250 and underlying modules such as, e.g., the hardware interface module 254. File cache management system 244 interfaces with the file system(s) 250 to manage the file cache 256 as a resource that may be shared between users of the computer system, e.g., on a per-workload basis.

Operating system 240 further comprises a system call interface module 242 that provides an interface between the operating system 240 and one or more application modules that execute on NAS device 200.

NAS device 200 further comprises storage media 280. For example, storage media 280 may be embodied as one or more arrays of magnetic disk drives, solid state drives or the like. Alternatively, storage media 280 may comprise optical, magneto-optical, or electro-optical storage media. Storage media 280 may be configured to implement RAID redundancy.

NAS device 200 further comprises a detection module 260. In some embodiments, a detection module is embodied as a software module that executes on processor(s) 212. By way of example and not limitation, a detection module may listen to network broadcast traffic to detect any devices that may be present on the network. When a device is detected, a detection module may connect to the device on a predetermined port to find out if the device contains required firmware and/or software to allow for automatic configuration for backup. In some embodiments, a detection module may also detect the presence of other NAS devices on the network and may establish peer-to-peer communication between NAS devices.

NAS device 200 further comprises a configuration module 262. In some embodiments, a configuration module is embodied as a software module that executes on processor(s) 212. By way of example and not limitation, a configuration module controls backup settings by device category, type or the like, based on a rules engine and may be granular to device identifying information. By way of example and not limitation, a configuration module may control what data on a connected device is backed up and/or synchronized, when to perform backups, or the like. In some embodiments, the software in a configuration module is preconfigured with common computing device settings for backup. In some embodiments, a configuration module backup settings may be modified to fit a client's preference.

NAS device 200 further comprises a coordination module 264. In some embodiments, a coordination module is embodied as a software module that executes on processor(s) 212. By way of example and not limitation, a coordination module may coordinate backup activities with other NAS devices on the network. Coordination of a backup may be used to distribute computing workload, redundant backup or the like.

NAS device 200 further comprises a NAS backup module 266. In some embodiments, NAS backup module is embodied as a software module that executes on processor(s) 212. In some embodiments, a NAS backup module may receive backup communication requests from a client, can initiate backup requests to a client, or the like, depending on configuration. In some embodiments, a NAS backup module may use image/block level identifiers for data to backup so data from various devices is only stored once and therefore reducing duplicate data storage. By way of example and not limitation, an identifier system may generate and assign key identifiers to a block of data thus allowing for detection of key identifiers already present in backup storage. In some embodiments, a NAS backup module may store a link to data already present in backup storage, as determined through a key identifier, as to reduce redundant storage.

NAS device 200 further comprises a device backup module 268. In some embodiments, a device backup module is embodied as a software module that executes on processor(s) 212. In some embodiments, a device backup module may initiate an intelligent backup and only backup modified data based on configurations provided by a NAS device.

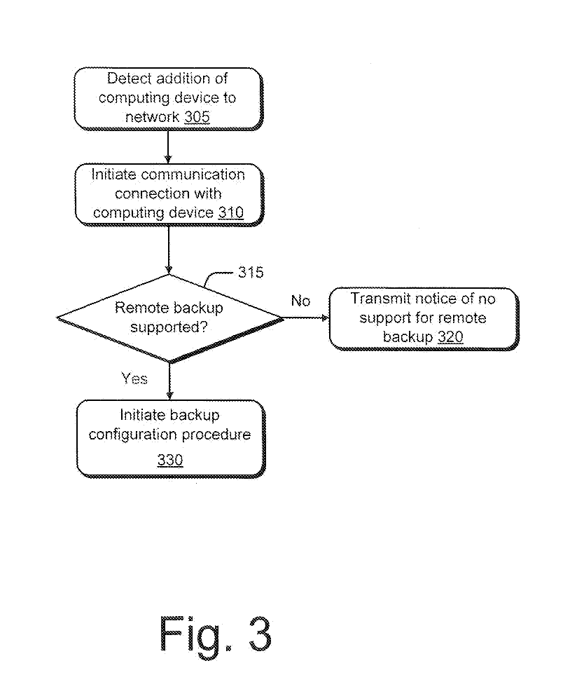

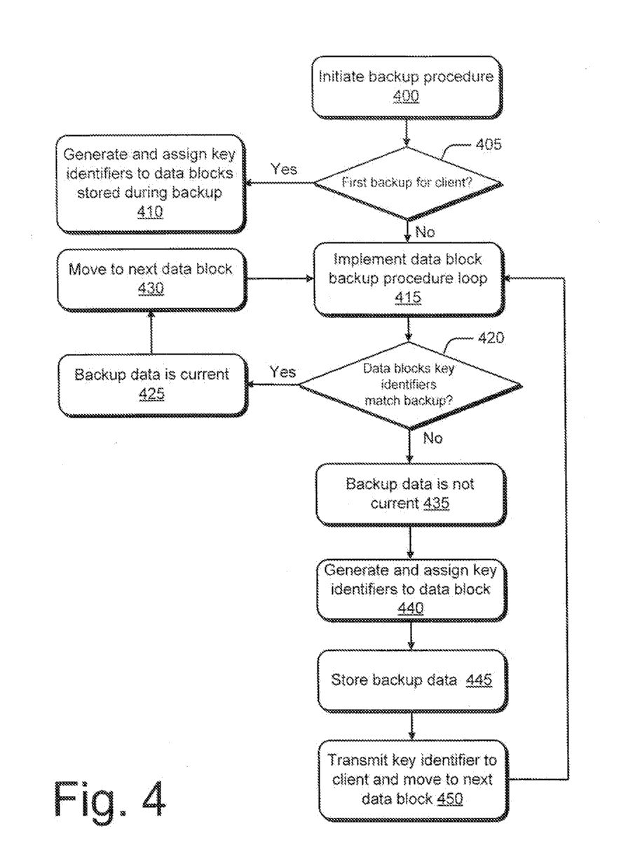

Operations implemented by some embodiments of detection module 260, configuration module 262, coordination module 264, NAS backup module 266 and/or device backup module 268 are described with reference to FIG. 3 and FIG. 4.

FIG. 3 is a flowchart illustrating operations in one embodiment of a method of backup configuration on a network attached storage device. In some embodiments, the operations depicted in FIG. 3 are implemented by the configuration module 262.

Referring to FIG. 3, at operation 305, a network attached storage device may detect the addition of one or more computing devices to a network. In some embodiments, detecting the addition of a computing device onto a network to which a network attached storage device is attached comprises: monitoring data traffic on the network, maintaining a list of computing devices connected to the network, and comparing data identifying a source of data traffic with one or more entries on the list of computing devices connected to the network. In some embodiments, detection of connected devices may be accomplished by a network attached storage device listening to network traffic and determining what devices are present through monitoring data traffic on the network. In some embodiments, a network attached storage device may maintain a list of computing devices connected to the network. In some embodiments, a network attached storage device may compare data identifying a source of data traffic with one or more entries on a list of computing devices connected to the network to determine whether the device has been connected to the network previously.

At operation 310, a network attached storage device may initiate a communication connection with one or more computing devices that may have been added to the network. In some embodiments, initiating a remote backup configuration procedure to configure a computing device for remote backup operations comprises; determining a device type associated with a computing device, and entering the device type into a rules engine to obtain a backup configuration setting associated with the device type. By way of example and not limitation, a communication connection may be initiated by a client, by preset configurations on a network attached storage device or the like.

Once a network attached storage device has communicatively connected with one or more computing devices on a network, a network attached storage device must determine if computing devices connected to the network allows for remote backup. In some embodiments, determining whether a computing device supports remote backup configuration comprises, detecting the presence of a firmware module on the computing device by accessing the contents of a predetermined memory location on the computing device. If at operation 315, one or more computing devices does not allow for remote backup, then at operation 320 notice is given that the computing device(s) do not support remote backup. By contrast, if at operation 315 one or more computing devices does allow for remote backup, then a network attached storage (NAS) device may initiate backup configuration procedures at operation 330. In some embodiments, configuring a backup procedure for at least one computing device connected to a network may comprise; detecting at least one additional network attached storage device connected to a network, and coordinating backup activities between multiple network attached storage devices.

In some embodiments, a NAS device may be configured to communicate with one or more remote server(s). In such embodiments, a NAS device may connect with the remote server(s) and download computing device configurations for data backup procedures. In some embodiments, a NAS device may maintain a table of configuration settings logically associated with computing device types. In some embodiments, a NAS device may periodically update a table of computing device configurations via a network connection to a remote server(s). In some embodiments, a network attached storage device may communicate with devices through prespecified ports to determine if the device contains the required firmware and/or software to allow for automatic backup and/or synchronization. In some embodiments, multiple network attached storage devices are connected to a network and may coordinate to distribute backup procedure loads.

By way of example, and not limitation, a network attached storage device may detect an encoded flag in a computing device that may point to a predetermined memory location in the computing device.

FIG. 4 is a flowchart illustrating operations in one embodiment of data backup on a network attached storage device. In some embodiments, the operations depicted in FIG. 4 are implemented by the detection module 260, the configuration module 262, the coordination module 264, the NAS backup module 266 and/or the device backup module 268.

At operation 400 a backup procedure is initiated. In some embodiments, the backup procedure may be initiated by a client. In some embodiments, a backup procedure may be initiated by a network attached storage device. In some embodiments, multiple network attached storage devices may be connected to a network and may be coordinated to share task responsibilities. In some embodiments, processing a backup procedure of at least a portion of data on connected computing devices may comprise using block level key identifiers for data to be backed up to avoid duplication of data storage. By way of example and not limitation, a network attached storage device may contain preset configurations of common computing devices that allow for remote backup.

If, at operation 405 the backup procedure is being performed for the first time, then at operation 410 a NAS device may generate and assign key identifiers to data blocks as it stores data during a backup procedure. In some embodiments, key identifiers may be sent to a client and stored in a memory location of a client computing device as well as on a network attached storage device. In some embodiments, a client may independently generate key identifiers for data blocks and transmit them to a network attached storage device. By way of example, and not limitation, when a backup procedure is performed on a computing device that does not contain much processing power, a network attached storage device may compute key identifiers for data blocks and transmit these key identifiers to the computing device.

In some embodiments, a client computing device and a network attached storage device may both generate and assign key identifiers to data blocks. In such embodiments, the client computing device and the network attached storage device may use the same function to generate the key identifiers to allow for synchronization during any subsequent backup procedures. By way of example and not limitation, key identifiers may be implemented as a hash function, a cyclic redundancy check (CRC) or any other mathematic function that may generate a unique value based on the contents of a memory block.

By contrast, if at operation 405 the backup procedure is not being performed for the first time, then a loop may be implemented to backup data blocks from computing devices at operation 415.

At operation 420 a network attached storage device may determine if a data block has a key identifier that matches data currently stored in backup. If, at operation 420, a data block has a matching key identifier present in a network attached storage device backup, then that data block is current (Operation 425), and the backup procedure may move to the next data block (Operation 430). In some embodiments, a link is provided to allow for access to data blocks already stored elsewhere is a network attached storage device backup storage. In some embodiments, linking to preexisting data blocks allows for reduction of storage of duplicate data which may be helpful in situations such as, but not limited to backing up operating system files from various devices.

By contrast, if at operation 420, a data block key identifier does not have a matching key identifier in a backup storage, then the data block is not current (Operation 435). At operation 440, a network attached storage device may generate and assign a key identifier to the data block and at operation 445, the data is stored.

Finally, at operation 450, key identifiers may be transmitted to a client and/or client computing device and the backup procedure may move to the next data block to be processed.

Some embodiments may be provided as computer program products, which may comprise a machine-readable or computer-readable medium having stored thereon instructions used to program a computer (or other electronic devices) to perform a process discussed herein. The machine-readable medium may comprise, but is not limited to, floppy diskettes, hard disk, optical disks, CD-ROMs, magneto-optical disks, ROMs, RAMs, erasable programmable ROMs (EPROMs), electrically erasable EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A method to manage backup services for remote clients of a network attached storage device, comprising:
detecting, in the network attached storage device, the addition of a computing device onto a network to which the network attached storage device is connected;
initiating, in the network attached storage device, a communication connection with the computing device;
determining whether the computing device supports remote backup configuration; and
in response to a determination that the computing device supports remote backup configuration, initiating, in the network attached storage device, a remote backup configuration procedure to configure the computing device for remote backup operations.

2. The method of claim 1, wherein detecting, in the network attached storage device, the addition of a computing device onto a network to which the network attached storage device is attached comprises:
monitoring, in the network attached storage device, data traffic on the network;
maintaining, in the network attached storage device, a list of computing devices connected to the network; and
comparing data identifying a source of data traffic with one or more entries on the list of computing devices connected to the network.

3. The method of claim 1, wherein determining whether the computing device supports remote backup configuration comprises:
detecting the presence of a firmware module on the computing device by accessing the contents of a predetermined memory location on the computing device.

4. The method of claim 1, wherein initiating, in the network attached storage device, a remote backup configuration procedure to configure the computing device for remote backup operations comprises:
determining a device type associated with the computing device; and
entering the device type into a rules engine to obtain a backup configuration setting associated with the device type.

5. The method of claim 1, wherein configuring, by the network attached storage device, backup procedure for at least one computing device connected to a network comprises:
detecting at least one additional network attached storage device connected to a network; and
coordinating backup activities between multiple network attached storage devices.

6. The method of claim 1, further comprising:
processing, by the network attached storage device, a backup procedure of at least a portion of data on connected computing devices comprises using block level key identifiers for data to be backed up to avoid duplication of data storage.

7. The method of claim 6, wherein using block level identifiers comprises:
generating a key identifier for a block of data;
assigning the key identifier to the block of data; and
storing a link to existing data located through the key identifier.

8. A computer program product comprising logic instructions stored on a computer-readable medium which, when executed by a computer processor, configure the processor to:
detect, in the network attached storage device, the addition of a computing device onto a network to which the network attached storage device is connected;
initiate, in the network attached storage device, a communication connection with the computing device;
determine whether the computing device supports remote backup configuration; and
in response to a determination that the computing device supports remote backup configuration, initiate, in the network attached storage device, a remote backup configuration procedure to configure the computing device for remote backup operations.

9. The computer program product of claim 8, further comprising logic instructions stored on a computer-readable medium which, when executed by a computer processor, configure the processor to:
monitor, in the network attached storage device, data traffic on the network;
maintain, in the network attached storage device, a list of computing devices connected to the network; and
compare data identifying a source of data traffic with one or more entries on the list of computing devices connected to the network.

10. The computer program product of claim 8, further comprising logic instructions stored on a computer-readable medium which, when executed by a computer processor, configure the processor to:
detect the presence of a firmware module on the computing device by accessing the contents of a predetermined memory location on the computing device.

11. The computer program product of claim 8, further comprising logic instructions stored on a computer-readable medium which, when executed by a computer processor, configure the processor to:
determine a device type associated with the computing device; and
consult entering the device type into a rules engine to obtain a backup configuration setting associated with the device type.

12. The computer program product of claim 8, further comprising logic instructions stored on a computer-readable medium which, when executed by a computer processor, configure the processor to:
detect at least one additional network attached storage device connected to a network; and
coordinate backup activities between multiple network attached storage devices.

13. The computer program product of claim 8, wherein logic instructions stored on a computer-readable medium which, when executed by a computer processor, configure the processor to process a backup procedure of at least a portion of data on connected computing devices comprises using block level identifiers for data to be backed up to avoid duplication of data storage.

14. The computer program product of claim 8, wherein logic instructions stored on a computer-readable medium which, when executed by a computer processor, configure the processor to use block level identifiers to:
generate a key identifier for a block of data;
assign the key identifier to the block of data; and
store a link to existing data located through the key identifier.

15. A network attached storage device, comprising:
at least one storage media;
a detection module to detect at least one computing device on a network;
a configuration module to configure, in network attached storage device, backup settings;
a coordination module to coordinate backup procedures;
a network attached storage backup module to backup at least of portion of data from a computing device to the storage media; and
a device backup module to backup only modified data from a computing device.

16. The network attached storage device of claim 15, wherein the detection module is further configured to:
scan for presence of at least one other network attached storage device on a network; and
use at least two network attached storage devices on a network to distribute backup process tasks.

17. The network attached storage device of claim 15, wherein the configuration module is further configured with specified backup settings for a number of common devices.

18. The network attached storage device of claim 15, wherein the network attached storage backup module is further configured to use data key identifiers to avoid redundant backup.

19. The network attached storage device of claim 15, wherein the device backup module is configured to limit data backup to data that has been modified since a prior backup.
